(19) United States
(12) Patent Application Publication
(10) Pub. No.: US 2017/0200068 A1
(43) Pub. Date: Jul. 13, 2017

(54) Method and a System for Object Recognition

(71) Applicants: Daniel Shimon COHEN, Ra'anana (IL); Yair ADATO, Tomer (IL); Dolev POMERANZ, Kfar Saba (IL); TRAX TECHNOLOGY SOLUTIONS PTE. LTD., Singapore (SG)

(72) Inventors: Daniel Shimon COHEN, Ra'anana (IL); Yair ADATO, Tomer (IL); Dolev POMERANZ, Kfar Saba (IL)

(73) Assignee: TRAX TECHNOLOGY SOLUTIONS PTE. LTD., Singapore (SG)

(21) Appl. No.: 15/316,657

(22) PCT Filed: Jun. 7, 2015
(86) PCT No.: PCT/IL2015/050576

§ 371 Date: Dec. 6, 2016

(30) Foreign Application Priority Data
Jun. 18, 2014 (IL) 233208

(51) Int. Cl. G06K 9/68; G06K 9/62; G06Q 10/08; G06K 9/00

(52) U.S. Cl. CPC G06K 9/6857; G06K 9/00979; G06K 9/6215; G06Q 10/087

(57) ABSTRACT

The present disclosure provides a method of image processing comprising: obtaining by an imaging device a low resolution version and a high resolution version of a retail image, the high resolution version of the retail image being a temporary file to be erased automatically after a predetermined time period; transmitting to a server the low resolution version of the retail image; upon receipt of a request from the server, the request including data representative of a contour of an unidentified item in the low resolution version of the retail image, cropping a high resolution item image from the high resolution version of the retail image, the high resolution item image corresponding to the contour of the unidentified item; and transmitting the high resolution item image to the server thereby enabling updating an item database.

### TECHNOLOGICAL FIELD

The present disclosure relates generally to the field of image processing. More particularly, the present disclosure relates to a method and system of image processing useful for improving object recognition in a retail environment.

### BACKGROUND

Object recognition relates to the task of identifying objects in an image or video sequence with a computer system. Generally, the computer system stores a set of one or more template images corresponding to a set of known products and analyzes an input image to check whether the known products can be detected in the input image.

Object recognition in a retail environment presents specific challenges. Particularly, objects in a retail environment have high variability because products' appearance attributes (e.g. size, color, amount of products in a package) are often modified by manufacturers in order to fit various requirements, such as special discounts for holidays, or for targeted customers. Furthermore, new products are regularly introduced in the market.

This increases difficulty for current object recognition systems.

### GENERAL DESCRIPTION

In the present application, the following terms and their derivatives may be understood in light of the below explanations:

Imaging Device

An imaging device may be an apparatus capable of acquiring pictures of a scene. In the following, the imaging device may comprise an image sensor, memory, a display communicatively coupled to the memory and a processing unit communicatively coupled to the memory, display and image sensor wherein the memory includes instructions for causing the processing unit to perform an image processing method. It should be understood that the term imaging device encompasses different types of cameras such as standard digital cameras, electronic handheld devices including imaging sensors, etc. Furthermore, in the following, it is understood that the images processed may preferably be “retail images” e.g. images acquired in a retail store of a retail unit such as a shelving unit displaying retail items.

Template Image

The term “template image” may refer to an image representing an item (product), the image being acquired in standard conditions i.e. the acquisition parameters (i.e. lighting, resolution, etc.) being set to predetermined values. The template images may be used for building a recognition process which enables distinguishing a given item among a set of predetermined items. In order to do so, the template images are preferably high resolution images, typically of about 4 megapixels. Furthermore, template images can be composed of a plurality of lower resolution template images. In certain embodiments, a template image exclusively represents the object i.e. no other objects are contained in the template image. In certain embodiments, a ratio between an actual size of the object and a pixel size of the imaged object is associated to the template image i.e. a template image is also characterized by a level of magnification. This may enable to link a size of a patch, extracted from a template image, with an absolute size.

Item Signature

The term item signature may refer to a series of one or more patches distinguishing a template image of a given item from a set of template images associated with a predetermined set of items. The item signature (also referred to as “visual signature”) of a given item may be built from the template image associated with the given item, taking into account the template images associated with the other items in the set of related items. A visual signature may comprise one or more patches hierarchically ordered with a spatial model. A visual signature may comprise a series of detectors, wherein each detector enables to detect a corresponding patch of the series of patches and the spatial model. The spatial model may define a relative positioning of at least some of the patches (and preferably each patch). For a given patch, the relative positioning may be expressed either with respect to a higher level patch or with respect to the primary patch. At least some of the patches (and preferably each patch) of the visual signature may also be associated with a property or discriminative condition. The visual signature forms a part model of an item which enables distinguishing the item from a set of related items (e.g. items belonging to the same class). The visual signature of an object is built while taking into account the other items of the set of related items. The visual signature definition is notably explained in Israeli patent application IL229806 assigned to the Applicant of the present application, the content of which is hereby incorporated by reference, at least with respect to the parts relating to the visual signature creation method.

The present disclosure provides a method of image processing comprising: obtaining by an imaging device a low resolution version and a high resolution version of a retail image, the high resolution version of the retail image being a temporary file to be erased automatically after a predetermined time period; transmitting to a server the low resolution version of the retail image; upon receipt of a request from the server, the request including data representative of a contour of an unidentified item in the low resolution version of the retail image, cropping a high resolution item image from the high resolution version of the retail image, the high resolution item image corresponding to the contour of the unidentified item; and transmitting the high resolution item image to the server thereby enabling updating an item database.

In some embodiments, the data representative of the contour comprise a position and size of the unidentified item in the low resolution version of the retail image and/or in the high resolution version of the retail image.

In some embodiments, the high resolution version of the retail image is an image as captured by the imaging device or a compressed version of said image.

In some embodiments, the method further comprises erasing the high resolution version of the retail image from the imaging device after the high resolution item image has been transmitted.

In some embodiments, when the request from the server is received by the imaging device after the predetermined time period, the method further comprising displaying to the user an invitation to acquire another image of the unidentified item.

In some embodiments, the invitation is based on the data representative of the contour of the unidentified item in the low resolution version of the retail image.

In some embodiments, the server comprises an item database associating identified items with visual signatures distinguishing said identified items, the method further comprising searching of the visual signatures by the server in the low resolution version of the retail image.

In some embodiments, the unidentified item in the low resolution version of the retail image does not correspond to any of the identified items in the item database.

In some embodiments, the method further comprises searching of the visual signatures by the server in the high resolution item image so as to check that the unidentified item cannot be recognized.

In some embodiments, the method further comprises: cropping by the server of the low resolution version of the retail image to form a basic item image around a contour of the unidentified item; storing the basic item image in the item database; and updating the visual signatures of the identified items using said basic item image.

In some embodiments, the basic item image is replaced by the high resolution item image in the item database after the high resolution item image is transmitted by the imaging device.

In some embodiments, the unidentified item is detected by searching by the server for a high level identifier within the low resolution version of the retail image and further comprising associating the unidentified item with said high level identifier in the item database if said high level identifier is recognized in the low resolution retail image.

In some embodiments, the high level identifier is selected among a set of high level identifiers configured to distinguish a set of expected trademarks.

In another aspect, the present disclosure provides a handheld imaging device comprising: memory; an image sensor; a display communicatively coupled to the memory; and a processing unit communicatively coupled to the memory, display and image sensor, wherein the memory includes instructions for causing the processing unit to perform an image processing method comprising: obtaining a low resolution version and a high resolution version of a retail image, the high resolution version of the retail image being a temporary file to be erased automatically after a predetermined time period; transmitting to a server the low resolution version of the retail image; upon receipt of a request from the server, the request including data representative of a contour of an unidentified item in the low resolution version of the retail image, cropping a high resolution item image from the high resolution version of the retail image, the high resolution item image corresponding to the contour of the unidentified item; and transmitting the high resolution item image to the server thereby enabling updating an item database.

In another aspect, the present disclosure provides a computer program product implemented on a non-transitory computer usable medium having computer readable program code embodied therein to cause the computer to perform an image processing method comprising: forming a low resolution version and a high resolution version of a retail image, the high resolution version of the retail image being a temporary file to be erased automatically after a predetermined time period; transmitting to a server the low resolution version of the retail image; upon receipt of a request from the server, the request including data representative of a contour of an unidentified item in the low resolution version of the retail image, cropping a high resolution item image from the high resolution version of the retail image, the high resolution item image corresponding to the contour of the unidentified item; transmitting the high resolution item image to the server thereby enabling updating an item database.

In another aspect, the present disclosure provides an image processing system comprising an imaging device and a server configured for performing the method previously described.

In another aspect, the present disclosure provides a data processing apparatus comprising: a receiver module configured for receiving a low resolution version of a retail image from an imaging device; an item database configured for storing a set of visual signatures associated with a set of predetermined identified items; a recognition module configured for: searching the visual signatures in the low resolution version of the retail image to recognize the identified items in the low resolution image; and detecting an unidentified item in the low resolution version of the retail image; a transmitter module configured for sending a request to the imaging device, the request including data representative of a contour of the unidentified item in the low resolution version of the retail image; wherein the receiver module is further configured for receiving from the imaging device, in response to the request, a high resolution item image derived from a high resolution temporary version of the retail image stored in the imaging device, said high resolution item image enabling updating the item database.

In some embodiments, the data processing apparatus further comprises a classifying module configured for updating the visual signatures using template images of the identified items and the high resolution item image.

In some embodiments, an unidentified item is detected by partially recognizing a stored visual signature.

In some embodiments, the recognition module is further configured for searching the visual signatures in the received high resolution item image so as to check that the unidentified item cannot be recognized.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates schematically an imaging device according to embodiments of the present disclosure.

FIG. 2 illustrates functional elements collaborating according to embodiments of the present disclosure.

FIG. 3 illustrates steps of an image processing method according to embodiments of the present disclosure.

### DETAILED DESCRIPTION OF EMBODIMENTS

Described herein are some examples of systems and methods useful for item recognition.

In the following description, numerous specific details are set forth in order to provide a thorough understanding of the subject matter. However, it will be understood by those skilled in the art that some examples of the subject matter may be practiced without these specific details. In other instances, well-known methods, procedures and components have not been described in detail so as not to obscure the description.

As used herein, the phrase “for example,” “such as”, “for instance” and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

Unless specifically stated otherwise, as apparent from the following discussions, it is appreciated that throughout the specification discussions utilizing terms such as “generating”, “determining”, “providing”, “receiving”, “using”, “transmitting”, “communicating”, “performing”, “forming”, “analyzing” or the like, may refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

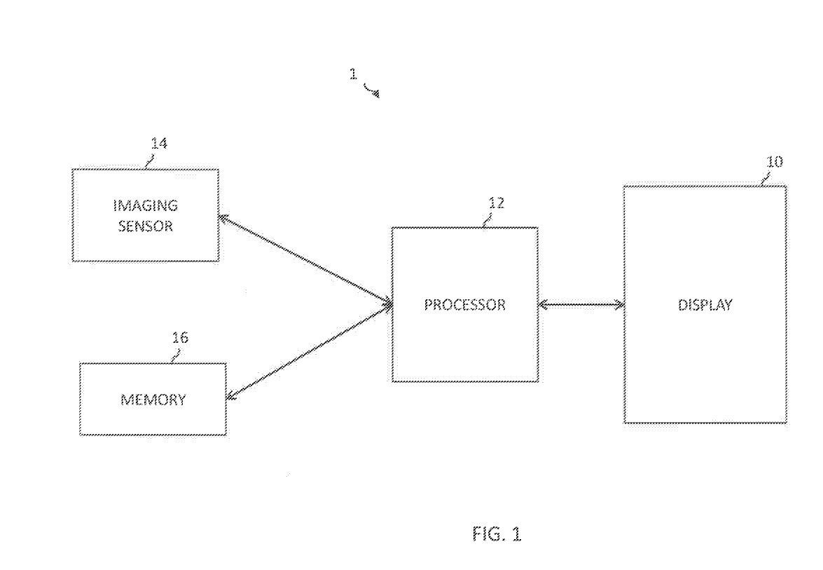

FIG. 1 illustrates a simplified functional block diagram of an imaging device 1 according to embodiments of the present disclosure. The device 1 may be a handheld electronic device and may include a display 10, a processor 12, an imaging sensor 14 and memory 16. The processor 12 may be any suitable programmable control device and may control the operation of many functions, such as the generation and/or processing of an image, as well as other functions performed by the electronic device. The processor 12 may drive the display (display screen) 10 and may receive user inputs from a user interface. The display screen 10 may be a touch screen capable of receiving user inputs. The memory 16 may store software for implementing various functions of the electronic device including software for implementing the image processing method according to the present disclosure. The memory 16 may also store media such as images and video files. The memory 16 may include one or more storage mediums tangibly recording image data and program instructions, including for example a hard-drive, permanent memory and semi permanent memory or cache memory. Program instructions may comprise a software implementation encoded in any desired language. The imaging sensor 14 may be a camera with a predetermined field of view. The camera may either be used in video mode, in which a stream of images is acquired upon command of the user, or in photographic mode, in which a single image is acquired upon command of the user.

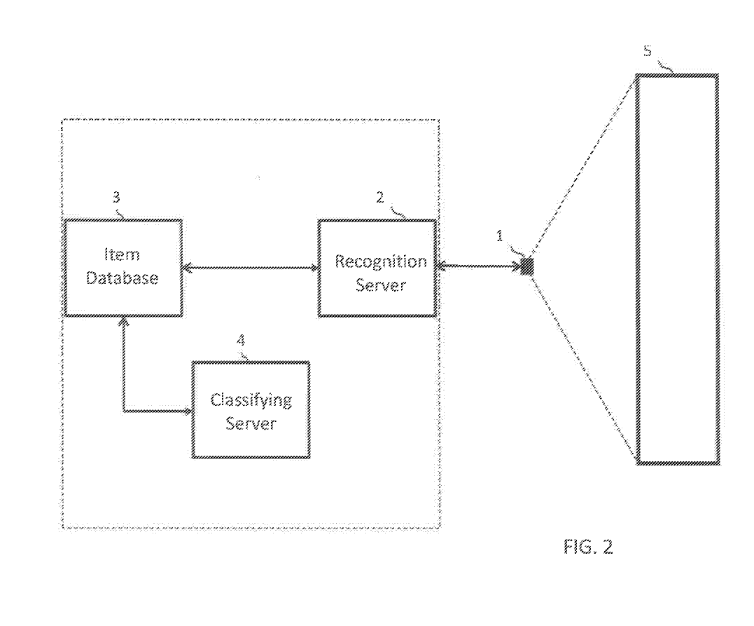

FIG. 2 illustrates generally a high level functional diagram of elements capable of implementing embodiments of the method described in the present disclosure. More particularly, FIG. 2 shows an imaging device 1 imaging a retail unit 5 and communicating with a recognition server 2. The retail unit 5 may be configured to display retail items. The retail unit 5 may be for example a shelving unit and the retail items may be of any kind, for example bottles, cans, boxes, etc. Preferably, the retail items may be rigid objects. The imaging device 1 may be configured to create a low resolution version and a high resolution version of the retail image. The retail image may be representative of a flank of the shelving unit and may contain images of one or more of the retail items. The low resolution version and the high resolution version of the retail image may result from compressing an image acquired by the imaging device 1. For example, the compression type may be a JPEG compression. The high resolution version of the retail image may be configured to be a temporary file which is erased automatically after a predetermined time period has elapsed from the creation of said high resolution version. Typically, the predetermined time period may be of less than an hour, for example between 1 and 10 minutes, or between 1 and 3 minutes, or in another example, 5 minutes. Further, the imaging device 1 may be configured to communicate with the recognition server 2. The imaging device 1 may be configured to transmit the low resolution version of the retail image to the recognition server 2 using a communication data link, for example a wireless communication data link such as a 3G or a Wifi connection. The imaging device 1 may further be configured to transmit at least a part of the high resolution version of the retail image to the recognition server 2 (and/or to a classifying server 4 as described below) if, before the predetermined time period has elapsed, a request from the recognition server 2 is received by the imaging device 1. The request may include data representative of a contour of an unidentified item in the low resolution version of the retail image. The imaging device 1 may be configured for cropping the high resolution version of the retail image according to said data in order to restrict the transmission to a region of interest in the high resolution version of the retail image, said region of interest corresponding to the unidentified item area (item area) within said high resolution version of the retail image. The cropping of the high resolution version of the retail image may thereby provide a high resolution item image (or high resolution clip).

The recognition server 2 may be configured to have access to an item database 3 which may store visual signatures of a set of predetermined items. The item database 3 may also store a set of high level identifiers configured to distinguish expected trademarks (brands, logos, labels, designs, etc.). This further enables the recognition server 2 to recognize said expected trademarks on items which do not belong to the predetermined set of items associated with the set of stored visual signatures. The visual signatures may form a classifier of the predetermined items and may be created based on a set of template images associated with the set of items. The server 2 may be capable of accessing the item database 3 for using the visual signatures so as to run a recognition process on the transmitted low resolution version of the retail image. The item database 3 may store the visual signatures associated with the set of predetermined items and may also store the template images associated with said items. In some embodiments, a low resolution template image (or a basic item image, as explained in more details below) may be stored and the item database may include a low resolution visual signature defined based on said low resolution template image.

It is noted that the item database 3 and the recognition server 2 may in certain embodiments be implemented on a single hardware or by a single software module. A classifying server 4 may carry out a method of defining one or more visual signatures associated with one or more products belonging to the predetermined set of products (a classifier). The classifying server 4 and the recognition server 2 may also be implemented on a single hardware or by a single software module. The recognition server 2 may carry out a method of object recognition on the images acquired by the imaging device 1 based on the visual signatures defined by the classifying server 4 and store on the item database 3. The recognition server 2 may therefore be configured to retrieve the defined visual signatures from the item database 3, as illustrated by the arrow showing communication between the recognition server 2 and the item database 3. The recognition server 2 may further be configured to receive at least one image derived from the imaging device 1, as illustrated by the arrow showing communication between the recognition server 2 and the imaging device 1.

The recognition server 2 may be configured to recognize any number of items related to the pre-defined visual signatures on the transmitted low resolution version of the retail image. Moreover, any number of instances of the same item could be detected in said version. The recognition server 2 may basically search if any of the one or more visual signatures can be detected in the captured image. In some embodiments, the recognition process may be executed in parallel using several computational units. Further, any search for inferior level patches could be parallelized and each top level patch and corresponding inferior level patches could be searched in parallel.

The classifying server 4 may be configured to define one or more visual signatures given in input of a set of template images associated with a predetermined set of items. As defined above, each visual signature may include a series of parts associated with their corresponding detectors and a spatial model. Preferably, after the visual signatures are defined, each detector of the visual signatures should be trained by applying techniques from the field of machine vision. The method of defining the visual signatures may be performed offline i.e. preliminarily to the image(s) acquisition or to the image(s) transmission. As described hereinafter, the method of defining one or more visual signatures is an iterative process (or alternatively, a recursive process). It may lead for each one of the products to a series of patches hierarchically ordered. Each patch from this series of patches may be associated with a detector configured for detecting the patch. The algorithm used in each detector may be adjusted according to the patch to be detected. Furthermore, each patch is associated with a relative position with respect to a higher patch in the series. The series of patches may also be associated with a spatial model defining a relative positioning of the patches. It is noted that generally, the relative position of an inferior level patch can be given with respect to any higher level patch. Preferably, the relative position is given with respect to the directly higher level patch or with respect to the top level patch. The visual signature associated with a product may be specific to this product and enable to distinguish the product among the set of predetermined products that may share similar appearance (i.e. related products).

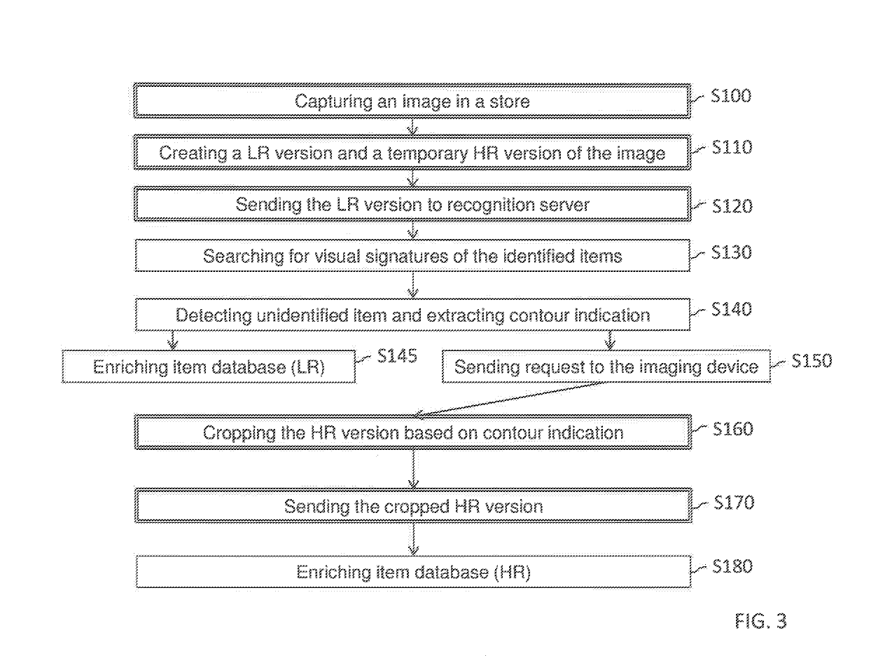

As explained in more detail below with reference to FIGS. 3-4, the present disclosure notably proposes a way of enriching the item database 3 when an unidentified item is detected in an image. Generally, a low resolution version of a retail image is sufficient for identifying accurately the items contained in said images using the recognition process based on the visual signatures. However, definition of the visual signatures is improved when performed on high resolution images. Therefore, the present disclosure proposes an automatic method which enables updating the visual signatures of the item database 3 while limiting the amount of data to be communicated by and stored on the imaging device 1. It is understood that since a visual signature enables to distinguish an item among a set of predetermined items, enriching the set of predetermined items with one or more additional items may modify the definition of the visual signature and therefore require the visual signature to be updated taking into account said additional item.

FIG. 3 is a flow chart illustrating steps of a method according to embodiments of the present disclosure. The method described below may be implemented by an imaging device collaborating with a remote server as previously described. The server may include a recognition server, a classifying server and an item database. The recognition server may perform an online (real-time) recognition process and the classifying server may perform an offline classifying process. In FIG. 3, steps which may be performed on the server side are represented by simple blocks while steps which may be performed at the imaging device side are represented by blocks surrounded by a double border.

In step S100, a retail image may be captured using the imaging device. For example, the retail image may be acquired in a store, in front of a shelving unit displaying retail items such as soda bottles.

In step S110, a low resolution version and a high resolution version of the retail image may be created by the imaging device. The high resolution version of the retail image may be created as a temporary image which is erased automatically after a predetermined time period has elapsed from its creation. In some embodiments, the low resolution version may weigh no more than 500 kb. In some embodiments, the high resolution version may weigh no more than 4 Mb. In some embodiments, the high resolution version may in fact be the retail image as acquired by the imaging device and an automatic deletion by the device may be programmed.

In a further step S120, the low resolution version of the retail image may be transmitted to the recognition server.

In a further step S130, the recognition server may carry out a recognition process on the low resolution version of the retail image. The recognition server may search if any of the one or more visual signatures stored on the item database can be detected in the captured image. There are several options for the recognition server to search for visual signatures in the images. In some embodiments, for each visual signature, the recognition server may search sequentially in the whole image for each patch of the visual signature. Thereafter, identification of a visual signature in the image may be decided based on the relative position of the detected patches by comparing with the relative positions of the inferior level patches in said visual signature. In some embodiments, for each visual signature, the recognition server may be configured to search, in the whole image, only the primary patch. Using the detector associated with said primary patch, one may derive scale and orientation indications to each candidate of product. Thereafter, for the subsequent patches, given these indications and the relative position indication associated with subsequent patches from the visual signature, the recognition server may be configured to search for inferior level patches in restricted regions of interest (ROI) of the low resolution version of the retail image.

In step S140, an unidentified item may be detected. The unidentified item may include some recognizable features but may not exactly match any of the visual signatures stored on the item database. In some embodiments, the unidentified item may be detected by detecting a high level identifier and by the unidentified item not fully matching any of the stored visual signatures. In some embodiments, an unidentified item may be detected by a partial recognition of one or more patches of a visual signature. For example, high level identifiers may be additionally searched in the low resolution version of the retail image. The high level identifiers may be stored in the item database and may enable to recognize expected trademarks. This may enable to associate the unidentified item with a known trademark (high level identifier). Furthermore, a contour of the unidentified item may be roughly determined using a size and optionally an orientation of said one or more detected patches or high level identifier. In some embodiments, an unidentified item may be detected manually by a user reviewing the low resolution version of the retail image. A low resolution item image may also be gathered for training the recognition process.

As shown in step S145, the item database may be enriched at this stage. A basic item image may be defined based on the contour of the unidentified item in the low resolution version of the retail image. The basic item image may include a cropping of the low resolution version of the retail image including the unidentified item. For example, the contour indication may comprise a position and size information about the unidentified item in the low resolution version of the retail image. In some embodiments, the basic item image may be processed by the classifying server in order to define a visual signature corresponding to the unidentified item and/or the already existing visual signatures corresponding to the predetermined set of items may be updated using said low resolution (basic) item image. However, as explained above, a quality of the visual signature may be improved by retrieving a higher resolution image of the unidentified item.

Therefore, in step S150, a request may be transmitted to the imaging device by the server. The request may cause the imaging device to transmit back to the server at least part of the high resolution version of the retail image, if the request is received before the predetermined time period expires. The request may include data indicative of the contour of the unidentified item in the low resolution version of the retail image. In some embodiments, when the request is sent after the predetermined time period has elapsed, an invitation may be displayed on the imaging device for inviting the user to acquire another image of the unidentified item. The invitation may include the basic item image previously defined, based on the low resolution version of the retail image and on the contour indication received in the request.

In step S160, upon receipt of the request from the server, the high resolution version of the retail image may be cropped based on the transmitted contour indication so as to isolate the unidentified item area from the high resolution version of the retail image, thereby defining a high resolution item image. The item area may correspond to the contour of the unidentified item and include the unidentified item.

In step S170, the high resolution (HR) item image may be transmitted to the server (directly to the classifying server or through the recognition server). Following the HR item image being transmitted, the high resolution version of the retail image may be deleted.

In step S180, the item database may be enriched using the HR item image. For example, the HR item image may be processed by the classifying server in order to define a visual signature corresponding to the unidentified item and/or the already existing visual signatures corresponding to the predetermined set of items may be updated. Furthermore, high level identifiers may be searched in the HR item image so as to associate the HR item image with a known high level identifier (brand/trademark for example). The basic item image may be replaced by the HR item image in the item database. In some embodiments, the recognition process may be run on the HR item image to try to recognize the stored visual signatures on the HR item image. Indeed, the low resolution version of the retail image may not provide a sufficient quality for distinguishing an item belonging to the predetermined set of items while the high resolution item image may provide such a sufficient quality. In this case, the enrichment of the item database may be optional and the method may directly enable to improve the recognition rate by providing selectively a high resolution image to the recognition server if an item remains unidentified after the recognition process is run on the low resolution version of the retail image. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A method of image processing comprising:
obtaining by an imaging device a low resolution version and a high resolution version of a retail image, the high resolution version of the retail image being a temporary file to be erased automatically after a predetermined time period;
transmitting to a server the low resolution version of the retail image;
upon receipt of a request from the server, the request including data representative of a contour of an unidentified item in the low resolution version of the retail image, cropping a high resolution item image from the high resolution version of the retail image, the high resolution item image corresponding to the contour of the unidentified item; and
transmitting the high resolution item image to the server thereby enabling updating an item database.

2. The method claim 1, wherein the data representative of the contour comprise a position and size of the unidentified item in the low resolution version of the retail image and/or in the high resolution version of the retail image.

3. The method of claim 1, wherein the high resolution version of the retail image is an image as captured by the imaging device or a compressed version of said image.

4. The method of claim 1, comprising erasing the high resolution version of the retail image from the imaging device after the high resolution item image has been transmitted.

5. The method of claim 1, wherein when the request from the server is received by the imaging device after the predetermined time period, the method further comprising displaying to the user an invitation to acquire another image of the unidentified item.

6. The method of claim 5, wherein the invitation is based on the data representative of the contour of the unidentified item in the low resolution version of the retail image.

7. The method of claim 1, wherein the server comprises an item database associating identified items with visual signatures distinguishing said identified items, the method further comprising searching of the visual signatures by the server in the low resolution version of the retail image.

8. The method of claim 7, wherein the unidentified item in the low resolution version of the retail image does not correspond to any of the identified items in the item database.

9. The method of claim 7, further comprising searching of the visual signatures by the server in the high resolution item image so as to check that the unidentified item cannot be recognized.

10. The method of claim 1, further comprising:
cropping by the server of the low resolution version of the retail image to form a basic item image around a contour of the unidentified item;
storing the basic item image in the item database; and
updating the visual signatures of the identified items using said basic item image.

11. The method of claim 10, wherein the basic item image is replaced by the high resolution item image in the item database after the high resolution item image is transmitted by the imaging device.

12. The method of claim 1, wherein the unidentified item is detected by searching by the server for a high level identifier within the low resolution version of the retail image and further comprising associating the unidentified item with said high level identifier in the item database if said high level identifier is recognized in the low resolution retail image.

13. The method of claim 12, wherein the high level identifier is selected among a set of high level identifiers configured to distinguish a set of expected trademarks.

14. An imaging device comprising:
memory;
an image sensor;
a display communicatively coupled to the memory; and
a processing unit communicatively coupled to the memory, display and image sensor, wherein the memory includes instructions for causing the processing unit to perform an image processing method comprising:
obtaining a low resolution version and a high resolution version of a retail image, the high resolution version of the retail image being a temporary file to be erased automatically after a predetermined time period;
transmitting to a server the low resolution version of the retail image;
upon receipt of a request from the server, the request including data representative of a contour of an unidentified item in the low resolution version of the retail image, cropping a high resolution item image from the high resolution version of the retail image, the high resolution item image corresponding to the contour of the unidentified item; and
transmitting the high resolution item image to the server thereby enabling updating an item database.

15. A computer program product implemented on a non-transitory computer usable medium having computer readable program code embodied therein to cause the computer to perform an image processing method comprising:
forming a low resolution version and a high resolution version of a retail image, the high resolution version of the retail image being a temporary file to be erased automatically after a predetermined time period;
transmitting to a server the low resolution version of the retail image;
upon receipt of a request from the server, the request including data representative of a contour of an unidentified item in the low resolution version of the retail image, cropping a high resolution item image from the high resolution version of the retail image, the high resolution item image corresponding to the contour of the unidentified item;
transmitting the high resolution item image to the server thereby enabling updating an item database.

16. The computer program product of claim 15, wherein the data representative of the contour comprise a position and size of the unidentified item in the low resolution version of the retail image and/or in the high resolution version of the retail image.

17. A data processing apparatus comprising:
a receiver configured for receiving a low resolution version of a retail image from an imaging device;
an item database configured for storing a set of visual signatures associated with a set of predetermined identified items;
at least one processor configured for:
searching the visual signatures in the low resolution version of the retail image to recognize the identified items in the low resolution image; and
detecting an unidentified item in the low resolution version of the retail image;
a transmitter configured for sending a request to the imaging device, the request including data representative of a contour of the unidentified item in the low resolution version of the retail image;
wherein the receiver is further configured for receiving from the imaging device, in response to the request, a high resolution item image derived from a high resolution temporary version of the retail image stored in the imaging device, said high resolution item image enabling updating the item database.

18. The data processing apparatus of claim 17, wherein the at least one processor is further configured for updating the visual signatures using template images of the identified items and the high resolution item image.

19. The data processing apparatus of claim 17, wherein an unidentified item is detected by partially recognizing a stored visual signature.

20. The data processing apparatus of claim 17, wherein the at least one processor is further configured for searching the visual signatures in the received high resolution item image so as to check that the unidentified item cannot be recognized.
